(19) United States
(12) Patent Application Publication
(10) Pub. No.: US 2003/0046158 A1
(43) Pub. Date: Mar. 6, 2003

(54) Method and system for enhancing mobile advertisement targeting with virtual roadside billboards

(76) Inventor: Jan Joseph Kratky, Raleigh, NC (US)

Correspondence Address: Mark D. Simpson, Esquire, Synnestvedt & Lechner, 2600 Aramark Tower, 1101 Market Street, Philadelphia, PA, 19107-2950, US

(21) Appl. No.: 09/945,998

(22) Filed: Sep. 4, 2001

(51) Int. Cl. G06F 17/60

(52) U.S. Cl. 705/14

(57) ABSTRACT

A method and system is disclosed for providing targeted advertising focused on an advertising target's directional movement towards a specific advertiser location, taking into consideration information pertaining to the travel path (e.g., road) on which the potential customer is traveling, the directional movement of the advertising target on that path, and the traffic patterns of the path and intersecting paths, among other criteria. Location-based advertising is focused on specific segments of paths leading up to a particular advertiser location. The direction of travel by advertising targets equipped with GPS-enabled personal display systems along these path segments is determined and advertising is broadcast only to travelers along the path within a specific segment and moving in a direction which will bring them to the particular advertiser's location.

### BACKGROUND OF THE INVENTION

1. Field of the Invention

The present invention relates to targeted advertising and more particularly, to a method and system for providing targeted advertising to individuals in public places, particularly along roadways and other avenues of travel. In particular, the position and direction of travel of potential customers is ascertained and utilized to enable the targeted purchase and/or dissemination of advertising along predetermined segments of an avenue of travel.

2. Description of the Related Art

Personal display systems (PDS), e.g., personal digital assistants such as Palm® devices or on-vehicle personal navigation systems, are becoming commonplace in society today. Their prevalence has made location-based advertising a reality. GeePS.com, for example, uses the wireless application protocol (WAP) along with a global positioning system (GPS) to deliver targeted ads to a hand-held PDS based on the location of the PDS. Information regarding the GeePS.com system can be found at the World Wide Web URL “www.GeePS.com”. See also “Location-based Advertising Reaches Consumers on the Go,” Editor and Publisher Online, Jul. 12, 2000 (available at www.Editorandpublisher.com). The basic premise behind the GeePS.com system is the belief that a customer will be interested in a given merchant location, and the products/services provided by that merchant, if he/she is within a predetermined-sized radius (referred to herein as an “n-mile radius” where “n” is a variable describing the 5 length of the radius) of that store or location. Whenever the person possessing the PDS gets within the n-mile radius, the advertisement is displayed on the PDS for the user to see.

In some respects, however, this premise is flawed. A particular example of one such flaw can be found with respect to a vehicle traveling along a highway that passes through the “n”-mile radius. FIG. 1 illustrates this flaw.

Referring to FIG. 1, a retail store 110 (Bob's) uses the above-described system to broadcast advertising inside an advertising circle 112 having a centerpoint 114 and a radius of length “n”. A highway 120 passes through the advertising circle 112 as illustrated and Bob's is located off of exit 485. A vehicle 100 traveling from point A to point B on highway 120 will pass through the advertising circle 112 and thus receive the advertising related to retail store 110. However, as is frequently the case, there may be no relationship between the presence of vehicle 100 on highway 120 and the desire of the driver of that vehicle to purchase goods or services from Bob's. In fact, frequently a road that provides no access to a merchant's location (e.g., road 121 in FIG. 1) may cut across the advertising circle 112 and will, by virtue of its location within the circle, be subjected to that merchant's advertising. Indeed, since vehicle 100 shown in FIG. 1 is past exit 485, the driver of vehicle 100 is much more likely to be interested in advertising related to an upcoming retailer 116 (Sally's) off of exit 486 as shown. However, the driver of vehicle 100 will be targeted for advertising from the retailer 110 simply because he or she is on a road that is within the advertising circle 112. Thus, much of the advertising done by retailer 110 is a waste of time and money since it will be directed to users that have no interest in visiting retailer 110.

Accordingly, it would be desirable to have an advertising system by which advertising for a particular merchant location (e.g., a store, restaurant, entertainment venue, etc.) is directed to potential consumers who have a high likelihood of traveling a route which will bring them within visible sight of the merchant location.

### SUMMARY OF THE INVENTION

The present invention is directed to a method and system providing targeted advertising not based upon an advertising radius or other vague proximity-type targeting, but instead focusing on a potential customer's directional movement towards a specific merchant location, taking into consideration information pertaining to the path on which the potential customer is traveling, the directional movement of the potential customer on that path, the position of the potential customer along the path, and the traffic patterns of the path and intersecting paths, among other criteria. In accordance with the present invention, location-based advertising is focused on specific segments of roads leading up to a particular merchant location. The direction of travel by potential customers equipped with GPS-enabled PDSs and their position along these path segments is determined and advertising is broadcast only to travelers along the road moving in a direction which will bring them to the particular merchant location.

### BRIEF DESCRIPTION OF THE DRAWINGS

FIG. 1 is a drawing illustrating deficiencies of the prior art;

FIG. 2 is a drawing illustrating benefits of the present invention over prior art methods;

FIG. 3 is a block diagram of a targeted advertising system according to an embodiment of the present invention; and

FIG. 4 is a flowchart illustrating an example of steps to be performed in accordance with the method of the present invention.

### DETAILED DESCRIPTION OF THE PREFERRED EMBODIMENTS

In accordance with the method of the present invention, a “Virtual billboard” company (referred to herein as a “service provider”) offers virtual billboard services to its customers (referred to herein as “advertisers”) along predetermined travel segments, e.g., a particular sections of a highways or roads. The advertisement(s) displayed using the virtual billboard service is directed to potential consumers (referred to herein as “advertising targets”) who are, in a typical application, driving in vehicles traveling along the particular highway section.

The advertising method of the present invention is referred to as a “virtual billboard” because, unlike a traditional billboard, the advertisement is not visible to all who pass along the travel segment. Instead, as described more fully below, the advertising is displayed on PDSs carried by the advertising targets based upon their position and direction of travel on the travel segment.

If the travel segment along which the advertising is going to be provided carries travelers in both directions (e.g., a two-way road), the service provider offers the advertiser the option of purchasing of the advertising in only one direction or in both directions, depending upon need, budgetary concerns, and the like. Since the system of the present invention detects directional movement of advertising targets, this allows the advertiser to focus its advertising expenditures on virtual billboards that will be viewed by advertising targets heading towards the advertiser's location, while enabling them to preclude the advertising to be seen by those traveling away from the advertiser's location.

Once the advertiser and service provider have agreed upon the specific advertisements to be displayed and travel segments on which virtual billboard services will be purchased from the service provider, the service provider, using known technology described below, selectively provides the service of transmitting the desired advertising to the desired travel segments in accordance with the agreement. Thus, in the display area of a PDS, advertising targets traveling in a given direction along a given travel segment will see the advertisement supplied by the service provider on behalf of the advertiser.

Pricing for the advertising can be determined according to a variety of factors including, for example, the time of day, day of the week, or other factors primarily related to the volume of traffic occurring on the travel segment at a particular time. For example, advertising transmitted during rush hour on a weekday might be more expensive than advertising transmitted along the same travel segment at midday; likewise, advertising transmitted along an interstate on the day before the Thanksgiving holiday might also be appropriate for the charging of premium pricing.

If desired, more complicated heuristics may be utilized to determine advertising content and advertising time slotting so that, for example, as described in more detail below, demographics of advertising targets and statistical information regarding their travel (e.g., long distance or short distance) can be taken into account.

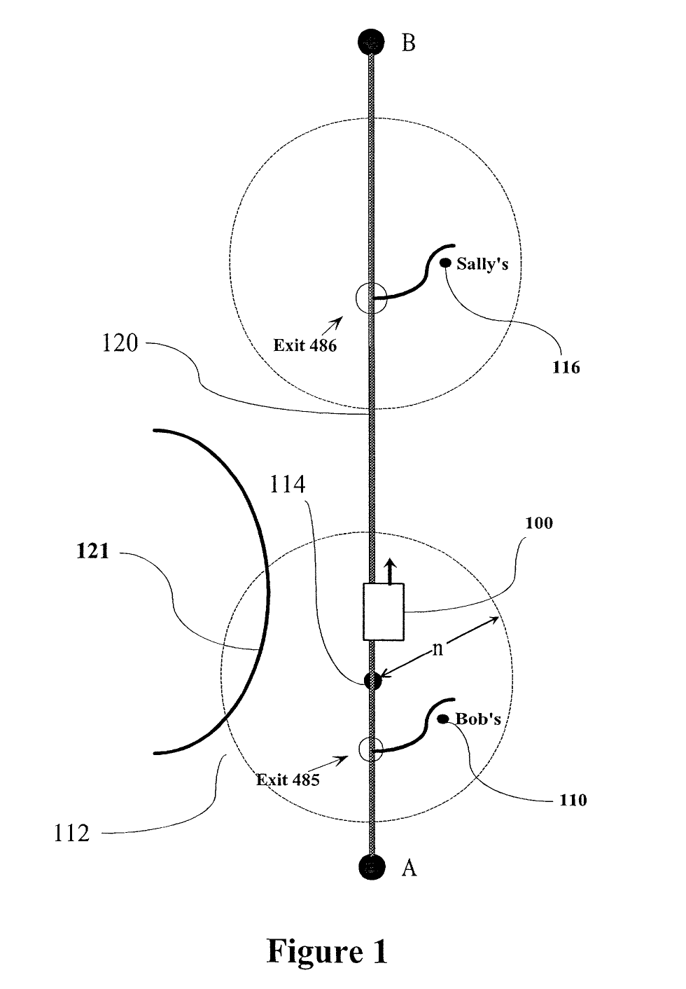

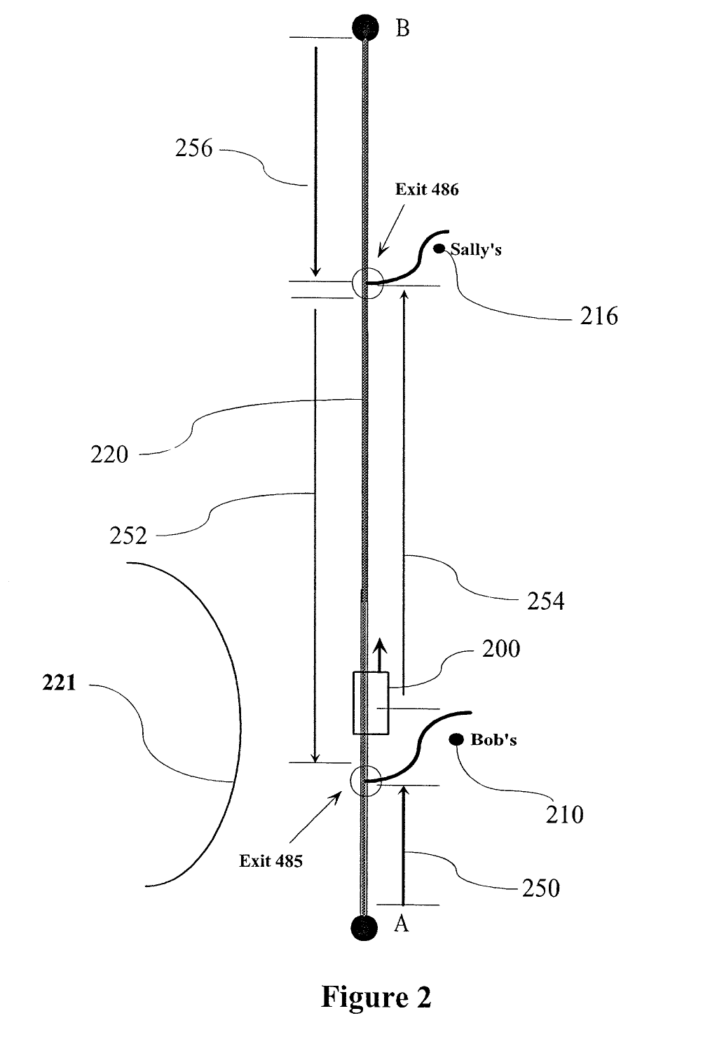

FIG. 2 illustrates the benefits of the present invention over the prior art methods. In FIG. 2, an advertising target is traveling in a vehicle 200 in a northbound direction on highway 220 just past exit 485. Similar to FIG. 1, in FIG. 2, two advertisers, “Bob's” (element 210) and “Sally's” (element 216), have store locations located along highway 220.

In accordance with the present invention, Bob's purchases advertising “space” from a service provider for highway 220 only for the segment 250 of highway 220 in the northbound direction and segment 252 in the southbound direction. Thus, if an advertising target has a PDS and is approaching exit 485 on highway 220, he or she will see advertising for Bob's. However, once past exit 485, the advertising for Bob's will cease. Further, if Sally's is utilizing the advertising system of the present invention, she can target her advertising to begin just past exit 485 northbound up to exit 486 by purchasing advertising for segment 254, and she can target southbound traffic approaching exit 486 by purchasing advertising along segment 256.

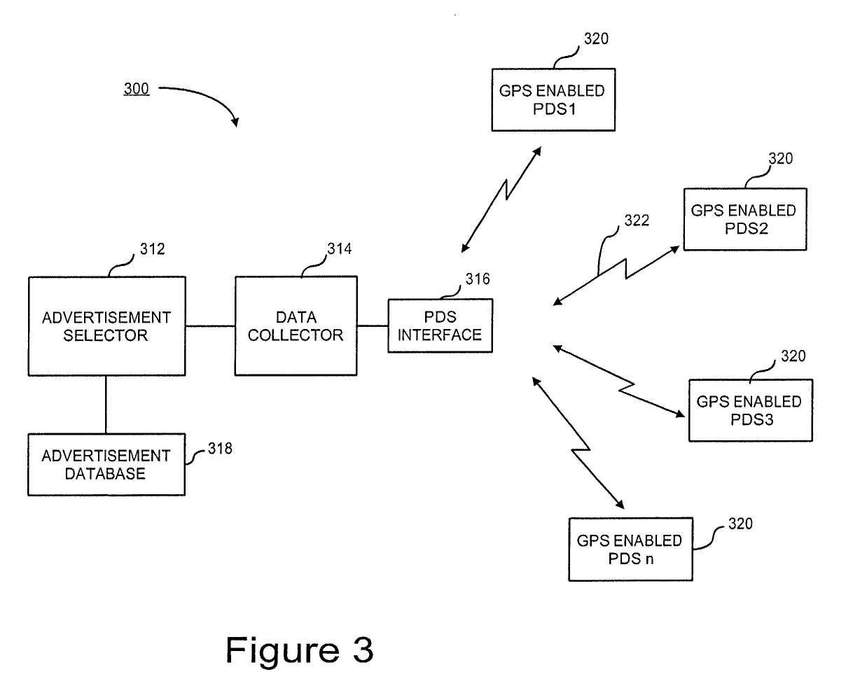

FIG. 3 is a block diagram of a targeted advertising system 300 according to an embodiment of the present invention. The system 300 can be used to display advertisements on PDSs located in vehicles traveling along a particular route. As shown in FIG. 3, the system 300 includes an advertisement selector 312, a PDS interface 316, an advertisement database 318, and one or more GPS-enabled PDSs 320.

The PDSs 320 can be GPS-enabled PDA's, on-board vehicle navigation systems, or other such systems capable of short-range wireless communications 322 with the PDS interface 316 according to known communication techniques such as infrared or optical communication or “Bluetooth” techniques. Bluetooth techniques involve providing a small, inexpensive radio unit into devices such as PDAs, mobile phones, PCs. Since the “Bluetooth” radio unit is designed according to a predetermined standard, it allows devices having the Bluetooth radio units to communicate directly with each other when they come into range without the use of cables or network infrastructure. The Bluetooth standard defines protocols for establishing communication between two selected devices and/or multiple selected devices. Further information regarding the Bluetooth standard and technology is available at the website of http://www.bluetooth.com.

To be able to deliver the appropriate advertising to each PDS 320, PDS interface 316 periodically receives GPS data from each PDS 320 which specifies their location. In addition to providing knowledge to the system regarding the location of each PDS 320, by periodically polling the GPS data from each PDS 320, the PDS interface 316 can also determine the direction of travel. This process is performed in accordance with known techniques, such as those techniques used with conventional on-board vehicle navigation systems, and the details thereof are thus not provided herein.

In a well-known manner, this GPS information is periodically input to data collector 314 so that information regarding each PDS 320 can be stored and utilized. In addition, if available, demographic information pertaining to the owner of the PDS(s) may be delivered to data collector 314 and stored therein for the purpose of targeted advertising.

An advertisement database 318 stores advertising information to be transmitted to each PDS 320, if appropriate. Advertisement selector 312 receives the positioning data from each PDS 320 and selects advertisements to be displayed based upon this data. Thus, for example, referring to FIG. 2, a vehicle equipped with a PDS and traveling from point A to point B northbound on highway 220 and approaching exit 485 will receive advertising materials for Bob's. Similarly, a southbound traveler along segment 252 will also receive advertising for Bob's. However, a vehicle that is located within segment 254 will instead receive advertising for Sally's.

The data collector 314 gathers the data from the PDS interface 316 and may organize the data according to predetermined categories if the data includes the above-mentioned demographic information. The advertisement selector 312 receives the organized data from the data collector 314 and selects advertisements to be displayed based on the data. The advertisement selector 312 may select one or more advertisements from a list of advertisements stored in the advertisement database 318 or other location according to predetermined criteria set by the advertiser and/or the service provider. Of primary importance with respect to the present invention is data related to the position and direction of travel of the PDS(s). However, if desired, the advertising may also be tailored to a particular demographic or set of demographics. For example, a particular advertiser, e.g., Bob's, may have an agreement with the service provider that their advertisements are to be displayed only if the collected data indicates that one or more of the PDS owners are male and/or are driving in a particular type of vehicle, e.g., an SUV. Then, according to this agreement, if the currently collected data indicates that such criteria have been satisfied, the advertisement selector 312 selects the advertisement for Bob's and displays it on the appropriate PDS's 320.

The transmission of the advertising to be displayed can be a accomplished on a real-time basis, that is, when an advertising target is determined to be located at a particular position and traveling in a particular direction along the travel path, the advertising information appropriate for that position and direction can be transmitted and displayed at that time, and when it is determined that the advertising target no longer possesses the correct positional/directional parameters, the transmission and display can be terminated.

In an alternative embodiment, the transmission of the advertising information can be scheduled to occur at any time (e.g., when the advertising target has entered a particular predefined region or zone; a periodic transmission to all advertising targets within a zone, etc.), and the display of the advertising information can be triggered based upon the positional/directional parameters of the advertising target.

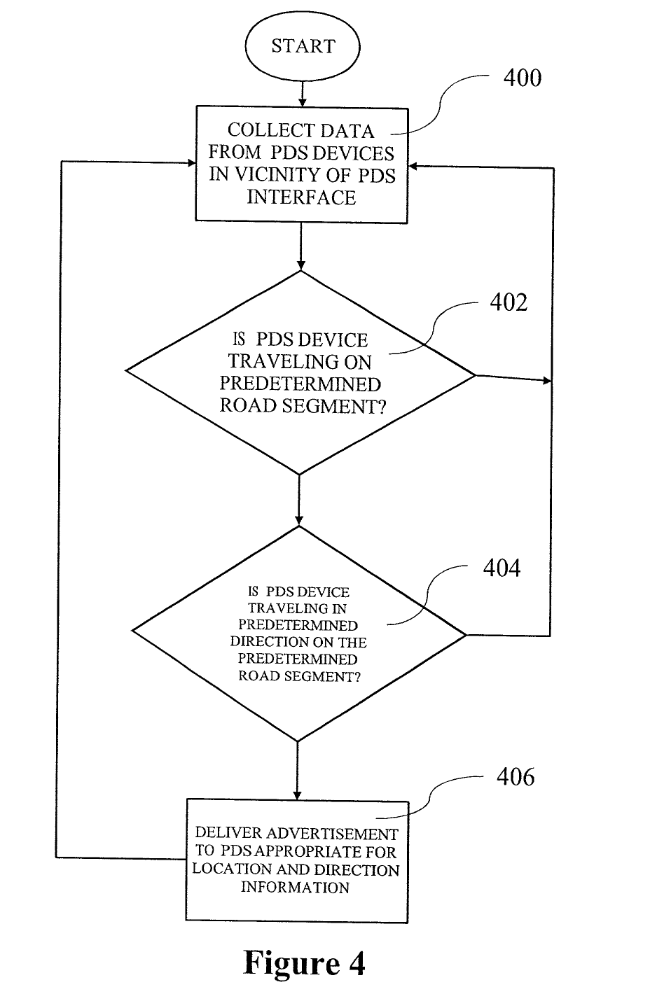

FIG. 4 is a flowchart illustrating an example of steps to be performed in accordance with a method of the present invention. Referring to FIG. 4, at step 400, data is collected in a well-known manner from PDSs within the vicinity of the PDS interface. This information will include directional and positional GPS data and may also include the above-described demographic information pertaining to the user of the PDS. This information is gathered and stored in data collector 314 of FIG. 3.

At step 402, a determination is made as to whether or not a particular PDS is traveling on a predetermined travel segment. This determination establishes the correlation between the location of the PDS and the particular advertisement to be delivered to the PDS if appropriate. If, at step 404 it is determined that a particular PDS is not traveling on a predetermined travel segment, the process reverts to step 400 where additional data is collected.

If, however, it is determined that the PDS is traveling on a predetermined travel segment, at step 406, a determination is made as to whether or not that PDS is traveling in a predetermined direction on the predetermined travel segment. If it is determined that, while the PDS is traveling on a predetermined travel segment, it is not going in the predetermined direction, the process reverts back to step 400 where additional data is collected.

However, if it is determined that the PDS is traveling in the predetermined direction on the predetermined travel segment, at step 408, the advertisement selector selects the appropriate advertisement from the advertisement database and, via the PDS interface, transmits the advertisement to the appropriate PDS. The process then reverts to step 400 to continue monitoring the location of the PDS device to determine if the advertisement should continue to be transmitted to that PDS.

The above description provides examples relating to the use of a PDS within a vehicle moving along a road. It is understood, however, that the present invention should not be so limited, and that the present invention finds application in any situation in which a PDS is being utilized where the location and direction of travel of the PDS is determinative of an eventual destination, e.g., a shopper walking in a mall, a visitor to an amusement park, etc. Further, while the above description gives examples in which a third party (the “service provider”) provides the novel service on behalf of an advertiser, it is also contemplated that the advertiser may provide the service on its own.

In addition, while the above description of the invention focuses primarily on providing advertising to persons traveling along a path that will bring them close to the location of the merchant paying for the advertising, the application of the present invention is not so limited. For example, a public transit authority (e.g., a mass transit train system) may purchase advertising to be transmitted to drivers traveling on a heavily traveled expressway during rush hour. The advertising could be directed to influencing drivers caught in traffic jams to utilize the train services offered by the public transit authority, even though there may be no train station locations located near the stretch of expressway to which the advertising is being transmitted. This is just one example of the many applications contemplated by the present invention.

Use of the present invention is an improvement over prior art systems for the advertiser, the advertising target, and the service provider. For example, using the present invention, the advertising target's PDS is not subjected to advertising for a location he/she is unlikely to visit; likewise, advertisers are able to target potential advertising targets more effectively. Further, a service provider implementing this method of advertising may realize greater advertiser satisfaction and may be able to increase advertising competition along with prices/revenues related thereto.

Although the present invention has been described with respect to a specific preferred embodiment thereof, various changes and modifications may be suggested to one skilled in the art and it is intended that the present invention encompass such changes and modifications as fall within the scope of the appended claims.

We claim:

1. A method for providing targeted advertising information to a moving advertising target traveling along a travel path, comprising the steps of:
determining the position and direction of travel of said moving advertising target along said travel path;
transmitting said targeted advertising information to said moving advertising target; and
displaying said targeted advertising to said moving advertising target based on the determined position and direction of travel.

2. A method as set forth in claim 1, wherein said transmitting step comprises at least the step of:
transmitting said targeted advertising information to said moving advertising target based on the determined position and direction of travel.

3. A method as set forth in claim 1, wherein said transmitting step comprises at least the step of:
transmitting said targeted information to said moving advertising target based on the determined position.

4. A method as set forth in claim 1, wherein said displaying step comprises at least the steps of:
identifying a particular advertising target;
correlating portions of said targeted advertising information with said particular advertising target; and
displaying said correlated portions of said targeted advertising information to said particular advertising target when said particular advertising target is determined to be located at a predetermined position and predetermined direction of travel along said travel path.

5. A method as set forth in claim 4, wherein:
said targeted advertising information is directed to advertisers located along said travel path; and
said predetermined direction of travel along said travel path comprises a direction along said travel path going toward at least one of said advertisers.

6. A method as set forth in claim 5, wherein said travel path comprises a road.

7. A method as set forth in claim 5, wherein said travel path comprises walkway.

8. A system for providing targeted advertising information to a moving advertising target traveling along a travel path, said system comprising:
means for determining the position and direction of travel of said moving advertising target along said travel path;
means for transmitting said targeted advertising information to said moving advertising target; and
means for displaying said targeted advertising to said moving advertising target based on the determined position and direction of travel.

9. A system as set forth in claim 8, wherein said means for transmitting comprises:
means for transmitting said targeted advertising information to said moving advertising target based on the determined position and direction of travel.

10. A system as set forth in claim 8, wherein said means for transmitting comprises:
means for transmitting said targeted information to said moving advertising target based on the determined position.

11. A system as set forth in claim 8, wherein said means for displaying comprises:
means for identifying a particular advertising target;
means for correlating portions of said targeted advertising information with said particular advertising target; and
means for displaying said correlated portions of said targeted advertising information to said particular advertising target when said particular advertising target is determined to be located at a predetermined position and predetermined direction of travel along said travel path.

12. A system as set forth in claim 11, wherein:
said targeted advertising information is directed to advertisers located along said travel path; and
said predetermined direction of travel along said travel path comprises a direction along said travel path going toward at least one of said advertisers.

13. A system as set forth in claim 12, wherein said travel path comprises a road.

14. A system as set forth in claim 12, wherein said travel path comprises walkway.
